(19) United States
(12) Patent Application Publication
(10) Pub. No.: US 2026/0250160 A1
(43) Pub. Date: Aug. 27, 2026

(54) Sorbent-Facilitated Desorption Ionization for Trace Detection of Water Contaminants

(71) Applicant: National Technology & Engineering Solutions of Sandia, LLC, Albuquerque, NM (US)

(72) Inventors: Ryan Davis, Rio Rancho, NM (US); Nathan R. Bays, Albuquerque, NM (US); Samantha M. Kruse, Albuquerque, NM (US); Brynal Benally, Farmington, NM (US)

(21) Appl. No.: 19/551,354

(22) Filed: Feb. 26, 2026

Related U.S. Application Data
(60) Provisional application No. 63/764,262, filed on Feb. 27, 2025.

(51) Int. Cl. C02F 1/28; C02F 101/36

(52) U.S. Cl. CPC C02F 1/285; C02F 2101/36; C02F 2303/16

(57) ABSTRACT

The present invention is directed to a method for rapid analysis aqueous analytes, such as water contaminants, by concentrating analytes on solid adsorbents and then detecting using mass spectrometric analysis via desorption ionization of the contaminant directly from the adsorbent surface. The contaminant may be PFAS. This general approach was demonstrated via indirect solution analysis (ISA) with desorption electrospray ionization (ISA-DESI) and laser desorption ionization (ISA-LDI). These method can use various adsorbent materials, including commercial porous carbons, activated alumina, and metal-organic frame-works (MOFs). As an example, perfluorooctanoic acid (PFOA) was rapidly detected in under five minutes from solutions with PFOA concentrations in the parts-per-trillion (ppt) range. The advantages of this ISA are that sample preparation and analysis are greatly simplified and accelerated relative to conventional methods, the method can maintain extremely low detection limits compared to conventional analysis, and it can be performed with low-cost, readily available materials.

### CROSS-REFERENCE TO RELATED APPLICATIONS

This application claims priority to U.S. Provisional Application No. 63/764,262, filed on Feb. 27, 2025, entitled “Sorbent-Facilitated Desorption Ionization for Trace Detection of Water Contaminants,” the entirety of which is incorporated herein by reference.

### STATEMENT REGARDING FEDERALLY SPONSORED RESEARCH OR DEVELOPMENT

This invention was made with government support under Contract No. DE-NA0003525 awarded by the United States Department of Energy/National Nuclear Security Administration. The government has certain rights in the invention.

### TECHNICAL FIELD

This invention relates to a method for the analysis of aqueous contaminants, by utilizing adsorbents to bolster desorption electrospray ionization-mass spectrometry/tandem mass spectrometry signals.

### BACKGROUND OF THE INVENTION

There is a growing demand for rapid and low-cost access to analytical testing for persistent environmental pollutants in public and private water systems. An example of this demand is the increased awareness and concern regarding per-and polyfluoroalkyl substances (PFASs), which are a class of anthropogenic compounds comprised of a fluoroalkyl chain. See R. C. Buck et al., Integr. Environ. Assess. Manag. 7 (4), 513 (2011). Due to the chemical stability of the carbon-fluorine bond, PFASs are persistent in the environment and can take up to 1000 years to degrade under ambient environmental conditions. See Z. Wang et al., Environ. Int. 69, 166 (2014). PFASs continue to see widespread use in both industrial and military applications, despite some species showing toxicity at parts-per-trillion (ppt) levels. See X. C. Hu et al., Environ. Sci. Technol. Lett. 3 (10), 344 (2016). Detection of PFAS in groundwater has been observed across the USA, including several sites at parts-per-million (ppm) levels, contributing to increased regulation and public awareness of these compounds. See X. C. Hu et al., Environ. Sci. Technol. Lett. 3 (10), 344 (2016); U.S. EPA, PFAS National Primary Drinking Water Regulation, (2024); and U.S. EPA, PFAS Strategic Roadmap: EPA's Commitments to Action 2021-2024, (2021).

Due to the widespread concern associated with PFAS and other pollutant exposures, there has been significant research focused on increasing throughput, improving sensitivity, and lowering the cost for water testing. However, commonly used methods for targeted testing can be time consuming for sample preparation and costly to R&D scientists and the general public. For example, depending on sample composition, a single sample can take anywhere from 20 minutes to several days using the solid phase extraction (SPE), liquid chromatography (LC)-mass spectrometry (MS) method in EPA Method 537 and can cost more than $100 per sample to send for analysis, which can be cost-prohibitive for broad applicability and wide-scale testing. See U.E.P. Agency, Method 1633: Analysis of Per- and Polyfluoroalkyl Substances (PFAS) in Aqueous, Solid, Biosolids, and Tissue Samples by LC-MS/MS, (2021).

Desorption ionization methods are promising approaches for high-throughput, targeted mass spectrometric screening because spectra can be collected quickly by scanning spatially across multiple samples and can be performed under ambient conditions (without requiring vacuum or temperature control). Methods such as matrix-assisted laser desorption ionization (MALDI)-MS or its variants, including surface-assisted laser desorption ionization (SALDI)-MS, have been explored for their application in screening for per-fluorinated compounds. See H. McDonald et al., J. Am. Soc. Mass Spectrom. 35 (6), 1272 (2024); C. Villette et al., Nat. Commun. 14 (1), 4244 (2023); D. Cao et al., Talanta 85 (1), 345 (2011); and J. A. Reynolds et al., J. Am. Soc. Mass Spectrom. 35 (2), 317 (2024). However, MALDI and SALDI require specialized sample preparation for analysis from solution (i.e., mixing the analyte with a matrix), which lowers throughput, raises costs for each sample analysis, and reduces access. See A. Jahnke and U. Berger, J. Chromatogr. A 1216 (3), 410 (2009); and Z. Takats et al., Science 306 (5695), 471 (2004). Another possibility is desorption electrospray ionization mass spectrometry (DESI-MS), which offers a rapid analysis of either a single point or a 1D or 2D distribution across a surface. See Z. Takats et al., Science 306 (5695), 471 (2004); C. C. Hsu and P. C. Dorrestein, Curr. Opin. Biotechnol. 31, 24 (2015); and I. D. Wilson and C. F. Poole, J. Chromatogr. B Analyt. Technol. Biomed. Life Sci. 1214, 123553 (2023). Indeed, some PFAS compounds have been identified and their distribution across a surface has been visualized. See P. H. N. Vo et al., Environ. Sci. Technol. Lett. 10 (5), 446 (2023). However, DESI is typically used on a flat, solid surface (such as a sectioned tissue on a glass slide) rather than to analyze trace aqueous analytes.

### SUMMARY OF THE INVENTION

The present invention is directed to a method for adsorbent-facilitated ionization desorption for trace detection of water contaminants, comprising adding an adsorbent into a solution containing at least one contaminant, equilibrating the adsorbent-contaminant solution mixture, extracting a contaminant-adsorbent sample from the equilibrated adsorbent-contaminant solution mixture, then performing desorption ionization-mass spectrometry targeting at least one of the contaminants on the adsorbent. In an embodiment, the mass spectrometry may be with any mass analyzer, such as time-of-flight or quadrupole, with or without tandem mass spectrometry. For example, the water contaminant can be a perfluoroalkyl substance (PFAS) such as perfluorooctanoic acid, a pharmaceutical or personal care product (PPCP) such as ibuprofen, a textile and industrially used dye such as Eriochrome Black T, an industrial pollutant such as triethylamine (TEA), or others. For example, the adsorbent can comprise porous carbon (e.g., activated carbon, nanostructured carbon, amorphous carbon, char, etc.), alumina, a molecular sieve (zeolites), clays, silicas, polymeric adsorbents, layered double hydroxides (LDHs), or a metal-organic framework (MOFs). The desorption ionization step can comprise desorption electrospray ionization, direct analysis in real-time (DART) ionization, or laser desorption ionization. Further, the invention enables multi-component analysis of two or more target analytes.

There is a need to accelerate water contaminant analysis to enable wide-spread, low-cost testing with high sensitivity. The present invention provides a novel application of surface desorption techniques to analyze an aqueous analyte from an adsorbent surface. The inventive method has a much higher throughput than conventional SPE/LC-MS methods. The sample preparation is straightforward, does not require a desorption step, and once the adsorbent has been removed for analysis, the MS analysis can be automated to screen large numbers of samples (e.g., 100 samples on a standard Waters DESI plate) within a few minutes. This is an improvement over liquid injections, where a single direct-infusion with ESI may take several minutes and a single LC run may take more than 15 minutes, not considering ‘rinsing’ runs in between each sample that can double the analysis time. At present, the limit-of-detection (LOD) of this method has only been developed for the principal exemplar, perfluorooctanoic acid, and was calculated to be 5 parts per trillion (ppt), relevant to strict regulatory limits. Further, other adsorbents amenable to this approach may improve detection limits.

According to an embodiment of the disclosure, a method for adsorbent-facilitated ionization desorption for trace detection of water contaminants that includes mixing a contaminant with an adsorbent in a solution; equilibrating the adsorbent and contaminant within the solution to concentrate the contaminant on the adsorbent; extracting a contaminant adsorbent sample from the solution; using desorption ionization to desorb the contaminant from the contaminant-adsorbent sample to form contaminant ions; and using mass spectrometric analysis of the contaminant ions to determine an amount of the contaminant in the solution. In an embodiment, the contaminant is concentrated on the adsorbent while the adsorbent and contaminant are brought to equilibrium in the solution.

### BRIEF DESCRIPTION OF THE DRAWINGS

The detailed description will refer to the following drawings, wherein like elements are referred to by like numbers.

FIG. 1 is a schematic illustration of a method of sorbent-facilitated desorption ionization for trace detection of perfluoroalkyl substances according to an embodiment of the disclosure.

FIG. 2 is a schematic illustration of an ISA-DESI method and the perfluorooctanoic acid (PFOA) chemical structure, showing where the [M-H]-peaks and [M-CO₂H]-peaks (arise at m/z=412.97 and 368.98, from their respective isotopic modelling according to an embodiment of the disclosure.

FIG. 3 shows an MS signal from an ISA-DESI analysis of PFOA-activated alumina. The inset shows the long-lived PFOA signal.

FIG. 4 is an example ISA-DESI analysis of activated alumina at decreasing initial concentrations of PFOA, showing an increase in signal over the blank substrate for samples prepared in solutions above 10 ppb.

FIG. 5 is a comparison of an ISA-DESI analysis of PFOA on adsorbents subjected to a 50 mL, 100 ppm PFOA solution.

FIG. 6A shows ISA-DESI signals for porous carbon CMK-3 exposed to various solutions of PFOA according to an embodiment of the disclosure.

FIG. 6B shows an ISA-DESI imaging analysis of CMK-3 subjected to decreasing initial concentrations of PFOA, with a spatial resolution at 1 ppm according to an embodiment of the disclosure.

FIG. 6C is a graph showing the performance of CMK-3 for ISA-DESI analysis at reduced concentrations of PFOA according to an embodiment of the disclosure.

FIG. 7A shows an ISA-LDI mass spectra analysis of PFOA on mesoporous carbon CMK-3.

FIG. 7B show an ISA-LDI time series analysis of PFOA on mesoporous carbon CMK-3 associated with the intensity at 368.98 m/z.

FIG. 7C show an ISA-LDI mass spectra analysis of PFOA on MOF-808.

FIG. 7D show an ISA-LDI time series analysis of PFOA on MOF-808 associated with the intensity at 368.98 m/z.

### DETAILED DESCRIPTION OF THE INVENTION

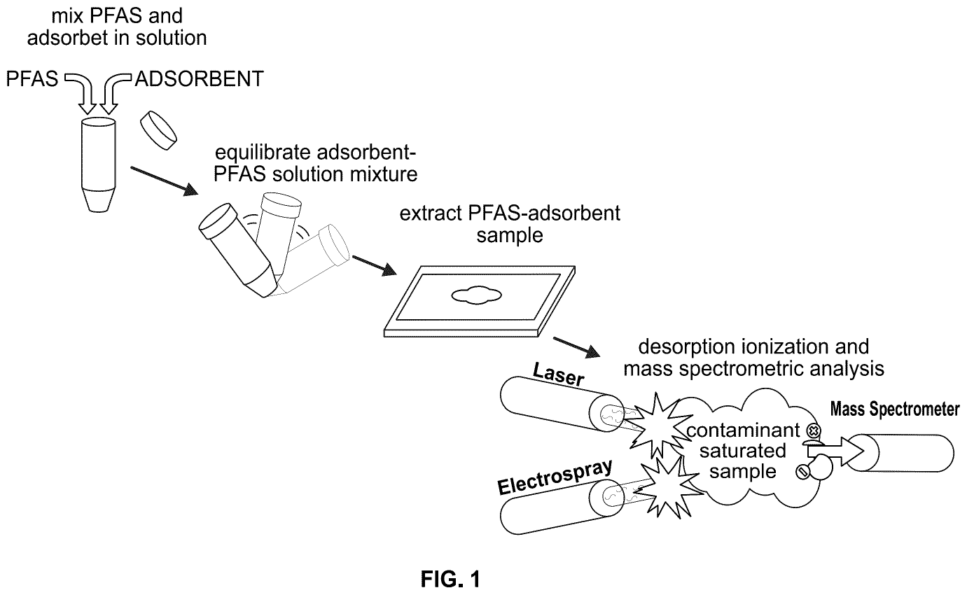

The present invention is directed to a method for indirect solution analysis (ISA) using an adsorbent-enhanced desorption ionization MS approach according to an embodiment of the disclosure, as shown in FIG. 1. The method used several adsorbents to sequester analytes from solution for analysis by surface desorption ionization methods. Perfluorooctanoic acid (PFOA) was selected as an exemplary analyte due to its widespread environmental presence, significant health concerns, and regulatory focus. See A. B. Lindstrom et al., Environ. Sci. Technol. 45 (19), 7954 (2011). However, other categories of environmental contaminants were also demonstrated including pharmaceutical and personal care products (PPCPs), industrial pollutants, textile and industrial dyes. The adsorbents pre-concentrate the target analyte for rapid screening using a desorption ionization method, including laser desorption ionization (LDI), direct analysis in real-time (DART) type ionization, and desorption electrospray ionization (DESI). These methods use relatively soft ionization (low fragmentation) to obtain ions of large molecules in the gas phase.

Conventionally, MALDI uses a laser energy-adsorbing matrix to create ions from large molecules with minimal fragmentation. DESI uses a charged particle solvent spray to generate molecular ions from a typically solid sample in an ambient environment via a droplet pick-up mechanism. Importantly, both techniques enable MS information to be obtained from samples in their native environment. See N. M. Morato and R. G. Cooks, Acc. Chem. Res. 56 (18), 2526 (2023).

The present invention uses an adsorbent in-lieu of a matrix. The adsorbent may be any adsorbent capable of adsorbing a specified contaminant. In various embodiments, the adsorbent may be a powdered or pelleted high surface area material of carbonaceous, a metal oxide, clay, silica, covalent organic framework (COF) or metal-organic framework (MOF). In an embodiment, the adsorbent may be a porous carbon, activated ceramic such as but not limited to alumina, clay, silica, layered double hydroxide, covalent organic framework (COF), metal-organic framework (MOF), a zeolite and a molecular sieve. In an embodiment, the zeolite may be of natural or synthetic origin, e.g., Faujasite, Zeolite X, Zeolite Y, Clinoptilolite, Linde Type A, etc.

In an embodiment, the porous carbon may be a mesoporous carbon, microporous carbon, microporous carbon, hierarchically structured carbon, amorphous carbon, nanostructured carbon (e.g., tubes, shells, plates), or other modified carbon.

In an embodiment, the metal oxides may be of alumina, titanium dioxides, layered double hydroxide, or of a variety of other porous metal oxide classes.

The MOF may be selected for specific adsorption of a desired contaminant. In an embodiment, the MOF may be MOF-808 or NU-1000.

The clays may be a selected to specific adsorption of a desired contaminant.

In an embodiment, the silicas may be of an ordered or unordered nature, such as amorphous or fumed silica, mesoporous silicas like MCM-41, SBA15, SBA16, or of other pore structures.

Analytical methods are largely agnostic to the selection of adsorbent, which should be based on optimizing the interaction with the target analyte with the adsorbent in a manner that it can be collected from a sample, then released via ionization during analysis. This can consider factors such as chemical nature of the adsorbent (polar/non-polar, specific chemical functional groups, and more) and physical nature of the adsorbent (pore size, total pore volume, total surface area, and more).

In an embodiment, the adsorbents may be micro-scale powders (particles 0.1-1000 microns in diameter to large macroscale aggregates (several centimeters in diameter) with the large aggregates easiest to work with). Secondary materials formed from adsorbents (such as adsorbents pelleted with a binder) are also acceptable and preferred to work with.

In various embodiments, the adsorbent may include surface functionalities.

The contaminants to be absorbed/detected are aqueous species, often but not limited to wastewater contaminants such as perfluoroalkyl substances (PFAS), pharmaceuticals and personal care products (PPCPs), industrial contaminants, and textile and industrial dyes. In an embodiment, the contaminant may be perfluorooctanoic acid (PFOA), ibuprofen, triethylamine, or Eriochrome Black T. In an embodiment, the contaminant may be detectable at a concentration in solution between parts per thousand to parts per trillion (ppt).

There is no need to desorb analytes from the adsorbent prior to analysis nor mix with a matrix molecule, which greatly simplifies sample preparation compared to conventional approaches. For example, the method can be applied directly to adsorbents used at wastewater treatment facilities for the physical removal of contaminants. This approach still relies on access to mass spectrometry but accelerates sample preparation and lowers costs relative to established methods. In particular, sample preparation is greatly simplified relative to conventional methods, and surface desorption ionization can be used for trace aqueous analytes from a liquid solution. The method can also utilize low-cost adsorbent materials.

### EXAMPLE

### Mass Spectrometric Detection of PFAS Using Adsorbent-Facilitated Desorption Ionization

The adsorbents used for ISA experiments included mesoporous carbons CMK-3 (ACS Materials) and disordered carbon (DC) powders. Two metal-organic framework materials, MOF-808 and NU-1000, were also used as powders for both ISA-DESI and ISA-LDI. Both MOFs were synthesized using literature procedures. See Y. Bai et al., Chem. Soc. Rev. 45 (8), 2327 (2016); and H. Furukawa et al., J. Am. Chem. Soc. 136 (11), 4369 (2014). Pelleted 3 Å molecular sieve (8-12 mesh) and activated alumina (8-14 mesh) were also tested in ISA-DESI.

For all indirect solution analyses, fresh adsorbent was measured by weight and added to 50 mL of PFAS solution. Adsorbent-solution mixtures were typically equilibrated for over 1 hour with agitation. For assessing overall speed of the analysis, equilibration times as little as 2 minutes were used. For powdered adsorbents, equilibrated samples were centrifuged, resulting in separation of the equilibrated PFAS-adsorbent from the solution, and the remaining PFAS solution was decanted. The solid adsorbents loaded with PFAS were then analyzed either after complete drying or when still damp.

The ISA-DESI and ISA-LDI experiments were performed using a Waters quadrupole time-of-flight (QToF) mass spectrometer, Synapt HDMS XS (Waters Corporation, MA, USA), with an ionization interchangeable source to switch between the LDI and DESI XS High-Performance Ion Sources. Data acquisition was in Mass-Lynx Version 4.2 (Waters Corporation, MA, USA). Instrument parameters were varied for optimization specific to PFAS and adsorbent material.

For ISA-DESI, regardless of the macrostructure of the adsorbent, all materials were adhered to a glass slide with double-sided tape. PFAS-adsorbent samples on a glass slide were loaded onto a two-dimensional stage and analyzed by MS in negative ion mode. The solvent spray composition was 98:2 methanol/water with 0.1% formic acid. Positioning of the sample stage and DESI spray source was optimized to maximize the PFOA ion signal for each surface depending on adsorbent geometry.

For ISA-LDI, the dried adsorbents were either adhered with tape or drop-cast into individual wells on a commercial MALDI plate. Drop-casting of the PFAS-sorbent samples was performed with either an acetone suspension, a water suspension, or an acetone-suspension with a concentration of 10 mg ml⁻¹ of MALDI matrix (1,5-diaminonaphthalene). The plated material was dried under ambient laboratory conditions (~22° C., ~20% relative humidity). The laser source for ISA-LDI was a frequency-tripled Nd: YAG laser (355 nm, pulsed at ≥100 μJ/pulse) with a pulse frequency of 2 Hz during MS data collection.

### ISA-DESI Analysis of PFOA-Sorbent Samples

Perfluorooctanoic acid (PFOA) was used as an exemplary PFAS analyte for proof-of-principle of the ISA method using readily available adsorbents. As shown in FIG. 1, PFOA under the conditions used herein produces two ions. These are observed at m/z=412.97, associated with deprotonated PFOA, and m/z=368.98, a fragment arising from the loss of the entire carboxylic head group. Both ions can be observed simultaneously at varying respective abundancies depending on the intensity of the energy or voltage applied to the sample.

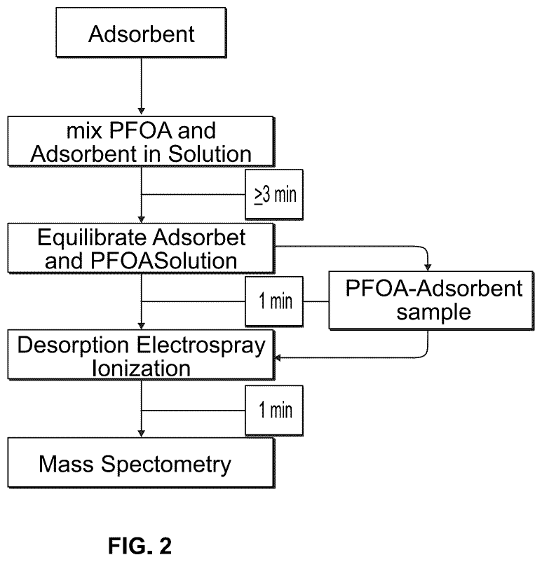

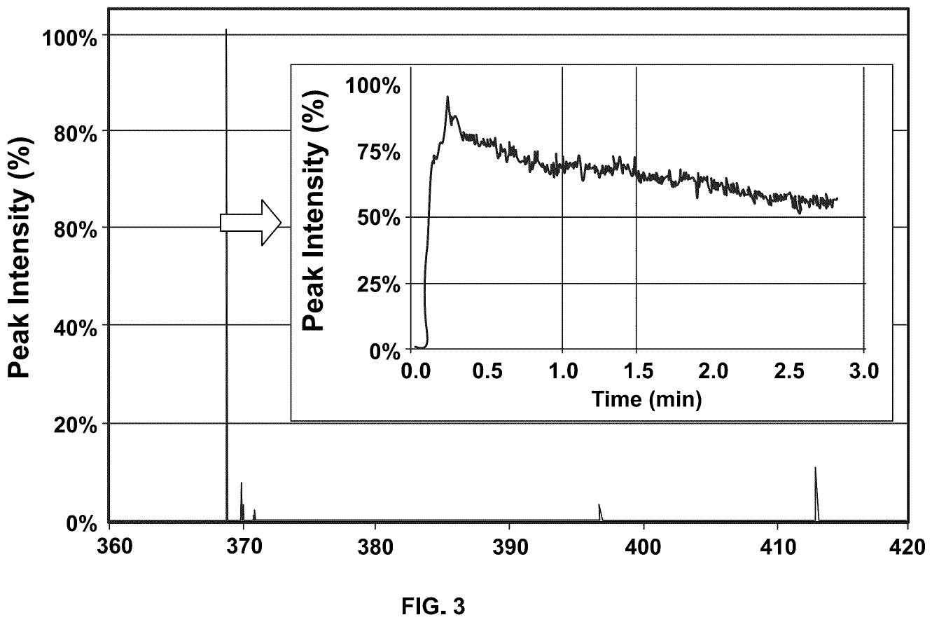

ISA-DESI was used to detect PFOA in a solution by sequestering the solution onto a sorbent surface and extracting the solid for analysis. This method is illustrated FIG. 2 using the alumina adsorbent and a solution of 1 ppm PFOA in water. When the DESI ion source is operated over the PFOA-laden alumina sorbent, a clear PFOA signal was obtained, as shown in FIG. 3. For contrast, no signal was obtained when 1 μL of 1 ppm PFOA solution is dried directly onto a glass substrate without a sorbent. This demonstrates that the adsorption of PFOA onto an adsorbent facilitates the use of DESI for PFOA detection. Notably, the MS signal persists over several minutes (inset) for the 1 ppm PFOA solution concentration. However, the MS signal lifetime decreased with decreasing solution concentration, lasting only several seconds in the case of 100 ppb PFOA before decaying to background. Thus, it may be preferable to initiate data collection prior to spraying the sorbent surface with the DESI source for low concentrations.

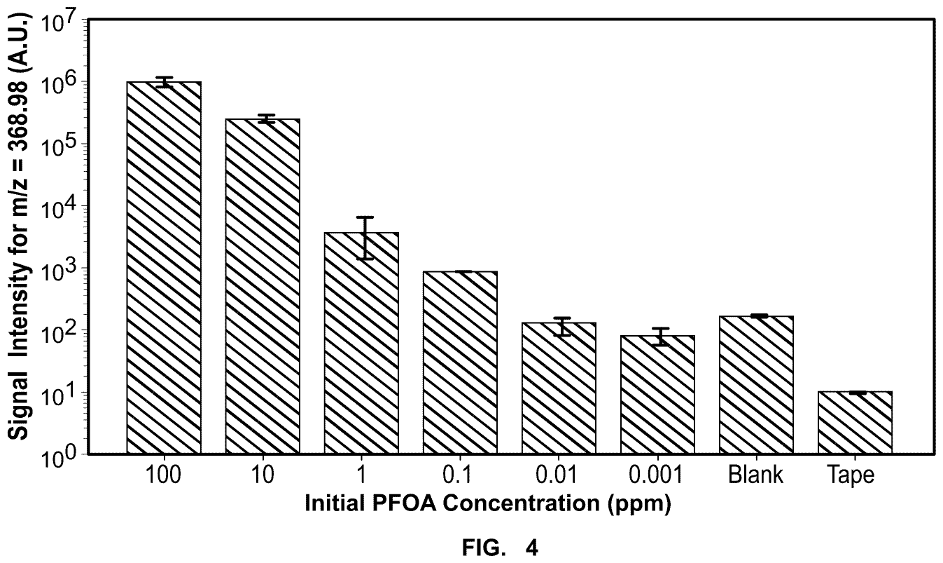

FIG. 4 is a plot of log(signal intensity) vs. log(PFOA concentration), showing a nearly linear trend (R2=0.952) for m/z=368.98 with alumina as the adsorbent, with a limit-of-detection (LOD) of ~40 ppb for this specific exemplar. (Notably, limits of detection are much lower in other examples.) This same trend is also seen in the signal intensity for m/z=412.97, with an initial concentration of ~100 ppb showing increased signal compared to the blank substrate. Interestingly, this LOD is well below the concentration range of 1 ppm (~1 mg/g PFOA adsorption) at which alumina sees a sharp uptake in its adsorption isotherm. These low PFOA concentrations (<1 ppm) are relevant to contaminated wastewater, suggesting that ISA-DESI may be a rapid screening tool for contaminated sites. See D. Skutlarek et al., Environ. Sci. Pollut. Res. 13 (5), 299 (2006).

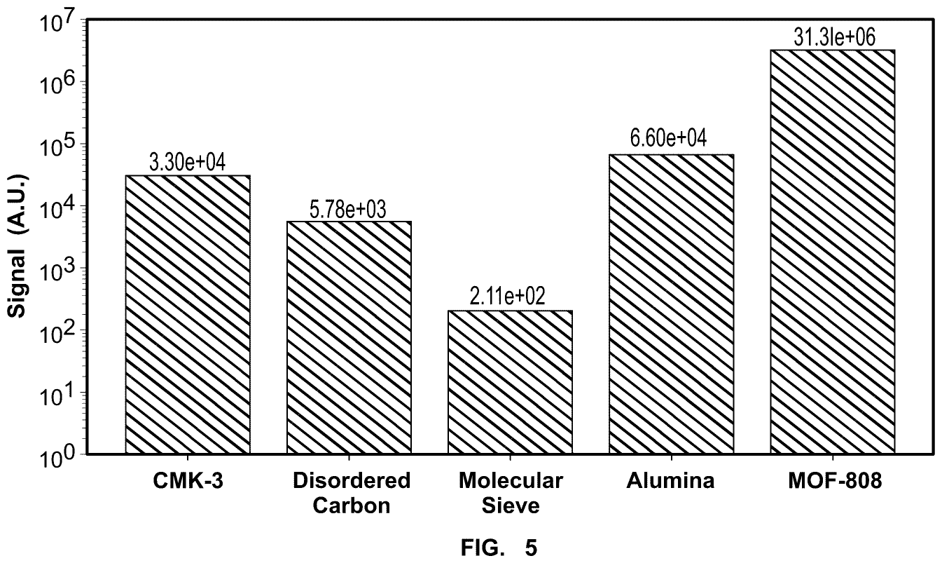

ISA-DESI analysis was further tested on different powdered adsorbents. FIG. 5 shows the maximum MS signal for a range of different common laboratory adsorbents used to sequester PFOA from 100 ppm solutions. Both mesoporous carbons produced signal three orders of magnitude higher than the blank substrate, with CMK-3 being the better of the two. The 3 Å molecular sieve was also tested, but was not as effective, likely due to the small pore size of the material allowing little PFOA to be adsorbed. Activated alumina produced a larger signal than the CMK-3. The MOF-808 sorbent produced the best signal by nearly two orders of magnitude, and also had the lowest LOD.

Although MOF-808 performed better than any other adsorbent, it is the costliest of all adsorbents tested. Activated alumina may have several advantages for widespread, low-cost use because it is a much cheaper and more readily available material. Further, alumina can be manufactured into smooth pellets, increasing the ease and consistency of analysis.

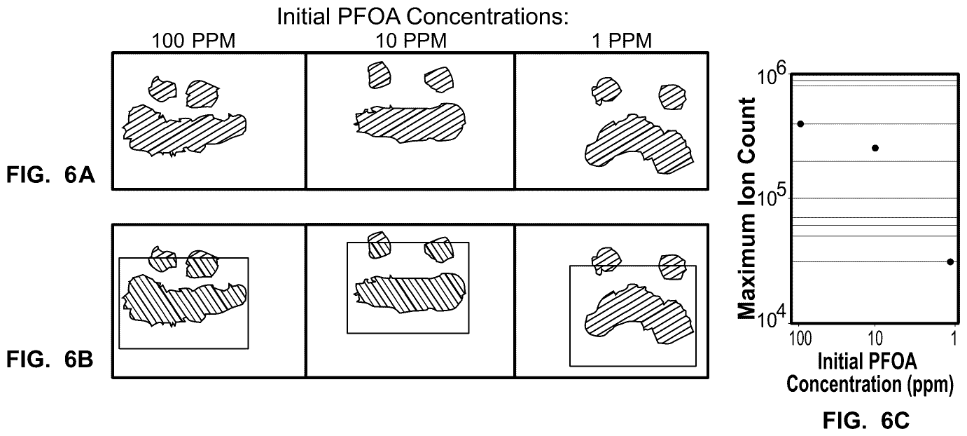

The porous carbon materials are also advantageous due to their low cost, availability, and safety. CMK-3 had performance comparable to activated alumina at 100 ppm, although the powdered form can make handling more difficult. As demonstrated in FIGS. 6A-6C, PFOA was detectable to at least 1 ppm on CMK-3. However, signal strength diminished greatly between 10 and 1 ppm. At 100 ppb, PFOA could no longer be positively identified on CMK-3. It is possible that stronger adsorbate-adsorbent interactions in carbon prevent desorption during ISA-DESI compared to alumina, or that alumina is better suited for the electrospray desorption process.

Other PFASs can also be analyzed using sorbent-facilitated desorption ionization method of the present invention. Accordingly, perfluorobutanesulfonic acid (PFBS) was also tested using the ISA-DESI technique. PFBS has sulfonic head groups instead of a carboxylic head group. PFBS was positively identified on a CMK-3 substrate at m/z=298.7. Thus, the method can be used for other contaminants of interest and contaminants with smaller chain lengths. Other common PFAS pollutants include perfluorooctane sulfonic acid (PFOS) and perfluorononanoic acid (PFNA).

### ISA-LDI Analysis of PFOA-Sorbent Samples

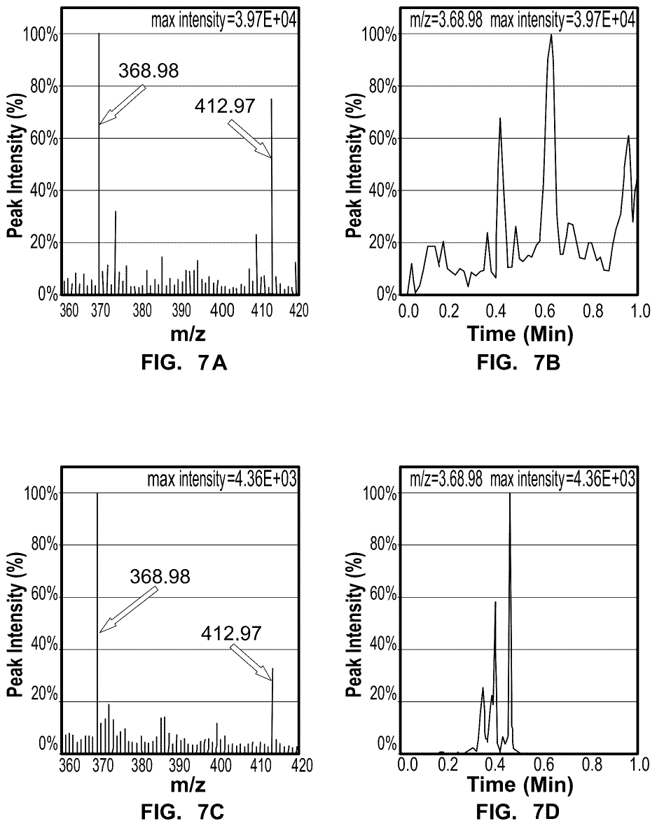

Indirect solution analysis was also investigated with laser desorption ionization (LDI). ISA-LDI was used to detect 200 ppm PFOA on a mesoporous carbon CMK-3 sorbent, as shown in FIG. 7A. The MOF materials (MOF-808 and NU-1000) were also tested at initial PFOA concentrations of 100 ppm, as shown in FIG. 7C. The ISA-LDI method produced a less stable signal relative to ISA-DESI, as demonstrated by the time series in FIGS. 7B and 7D. This may be due to inhomogeneities in the sample's distribution or ability of the sample to adsorb the laser.

Decreasing the initial concentration of PFOA on CMK-3 down to 10 and 1 ppm resulted in no positive identification of PFOA, demonstrating that although the ISA-LDI method works for high concentrations, it lacks sensitivity. The low sensitivity of ISA-LDI is likely due to the simultaneous ablation of the adsorbent which produces an abundance of background ions that generate noise and can interfere with the generated PFOA ions, reducing the detectable analyte signal. However, ISA-LDI may be effective at high PFOA initial concentrations, providing an alternate route of analysis for individuals with access to a MALDI source but no DESI source. Different sorbents or laser sources may reduce background noise and ultimately improve detection limits for ISA-LDI.

The present invention has been described as sorbent-facilitated desorption ionization for trace detection of perfluoroalkyl substances. It will be understood that the above description is merely illustrative of the applications of the principles of the present invention, the scope of which is to be determined by the claims viewed in light of the specification. Other variants and modifications of the invention will be apparent to those of skill in the art.

1. A method for adsorbent-facilitated ionization desorption for trace detection of water
contaminants comprising:
mixing a contaminant with an adsorbent in a solution;
concentrating the contaminant on the adsorbent;
extracting a contaminant adsorbent sample from the solution;
using desorption ionization to desorb the contaminant from the contaminant-adsorbent sample to form contaminant ions; and
using mass spectrometric analysis of the contaminant ions to determine an amount of the contaminant in the solution.

2. The method of claim 1, wherein the contaminant is selected from a group comprising
perfluoroalkyl substances (PFAS), organic dyes (e.g., Eriochrome black T), organic amines (e.g., triethylamine), pharmaceuticals (e.g., ibuprofen) and any other organic molecules.

3. The method of claim 1, wherein the contaminant is perfluorooctanoic acid or perfluorobutanesulfonic acid.

4. The method of claim 1, wherein the adsorbent is selected from a group comprising porous
carbon, alumina, a molecular sieve, or a metal-organic framework (MOF).

5. The method of claim 1, wherein the desorption ionization comprises desorption electrospray ionization or laser desorption ionization.

6. The method of claim 1, wherein the adsorbent is a MOF.

7. The method of claim 6, wherein the MOF is selected from the group consisting of MOF-808
and NU-1000.

8. The method of claim 1, wherein the contaminant is at a concentration of less than 1,000 ppm
in the solution.

9. The method of claim 1, wherein concentrating the contaminant of the adsorbent is performed
while equilibrating the adsorbent and contaminant within the solution.

10. The method of claim 1, wherein the adsorbent has a particle size between 0.1-100,000 microns.
